(19) United States
(12) Patent Application Publication
(10) Pub. No.: US 2020/0030908 A1
(43) Pub. Date: Jan. 30, 2020

(54) CONTROLLER

(71) Applicant: Fanuc Corporation, Yamanashi (JP)

(72) Inventor: Takeshi Nogami, Minamitsuru-gun (JP)

(73) Assignee: Fanuc Corporation, Yamanashi (JP)

(21) Appl. No.: 16/519,044

(22) Filed: Jul. 23, 2019

(30) Foreign Application Priority Data
Jul. 26, 2018 (JP) 2018-140441

(51) Int. Cl. B23K 26/03; B23K 26/08; B23K 26/26

(52) U.S. Cl. CPC B23K 26/032; B23K 26/26; B23K 26/0884

(57) ABSTRACT

A controller that determines a welding condition depending on a work state includes a work state monitoring unit that monitors the work state at a welding position for future, a welding condition controlling unit that calculates a statistical value based on the work state at the welding position for future and past and determines the welding condition depending on the statistical value, and a welding unit that performs welding at a current welding position based on the welding condition. The controller enables appropriate control of welding condition switching.

### RELATED APPLICATION

The present application claims priority to Japanese Application Number 2018-140441 filed Jul. 26, 2018, the disclosure of which is hereby incorporated by reference herein in its entirety.

### BACKGROUND OF THE INVENTION

### Field of the Invention

The present invention relates to a controller, and particularly, to a controller that enables appropriate control of welding condition switching.

### Description of the Related Art

There is a technology allowing a controller to perform welding by controlling a robot that has a welding head and a sensor attached to the distal end of its arm, with a state of welding region monitored by the sensor (see FIG. 1). When distortion or the like arises in the work due to welding, this technology allows the sensor to detect the distortion to feed back to the controller and allows the controller to change the welding condition depending on the distortion. For example, a controller that performs butt welding by weaving switches the width of weaving welding depending on a work gap d according to the setting shown in FIG. 2.

JP 2003-170284 A discloses a laser welding apparatus capable of weaving with a laser beam, which detects a gap size of an object to be welded with an optical sensor and controls the width of weaving welding depending on the detected data.

Conventional controllers may have a problem that a welding condition frequently switches when a state detected by a sensor is around a threshold for welding condition switching.

This problem will be described by taking a controller that performs weaving welding according to the setting shown in FIG. 2 as an example. This controller determines whether a width of weaving welding is to be 2 mm or 3 mm depending on whether a work gap is smaller than 1 mm or equal to or larger than 1 mm. In the case of weaving welding by butting workpieces so that the work gap d becomes wider as welding progresses as shown in FIG. 3, a relationship between the work gap d and the passage of processing time is shown in the graph of FIG. 4.

In the graph of FIG. 4, the chain double-dashed line shows a true (i.e. ideal) relationship between the work gap d and the passage of processing time. This ideal relationship indicates that once the work gap d is equal to or larger than 1 mm, the width of weaving welding switches from 2 mm to 3 mm just one time according to the setting of the FIG. 2. However, an actual work gap d detected by a sensor often has fluctuation as shown in FIG. 5. This is shown by the solid line in the graph of FIG. 4, indicating that the work gap d detected by the sensor varies non-linearly. The work gap d may thus hover around a threshold of 1 mm for switching the width of weaving welding as shown in the right diagram (enlarged diagram) of FIG. 4.

In such a case, the controller will frequently switch the width of weaving welding to 2 mm or 3 mm as shown in the right diagram of FIG. 4 and FIG. 6. This may result in a phenomenon like chattering and deterioration of welding quality. Note that a similar problem may occur in various welding conditions such as, for example, focus and laser frequency as well as the width of weaving welding.

### SUMMARY OF THE INVENTION

The present invention is made to solve such a problem and an object of the present invention is to provide a controller that can appropriately control welding condition switching.

According to an embodiment of the present invention, a controller that determines a welding condition depending on a work state includes a work state monitoring unit that monitors the work state at a welding position for future, a welding condition controlling unit that calculates a statistical value based on the work state at the welding position for future and past and determines the welding condition depending on the statistical value, and a welding unit performs welding at a current welding position based on the welding condition.

In the controller according to an embodiment of the present invention, the welding condition controlling unit may keep the welding condition unchanged until the statistical value varies beyond a predetermined threshold after determining the welding condition.

In the controller according to an embodiment of the present invention, the work state may be a width between a plurality of workpieces to be welded, and the statistical value may be an average of the width between the workpieces.

According to the present invention, it is possible to provide a controller that can appropriately control welding condition switching.

### BRIEF DESCRIPTION OF THE DRAWINGS

The above and other objects and features of the present invention will be apparent from the following description of embodiments with reference to the accompanying drawings in which:

FIG. 1 is a diagram showing a conventional welding machine and a conventional controller;

FIG. 2 is a diagram illustrating a conventional method of determining a welding condition;

FIG. 3 is a diagram illustrating the conventional method of determining a welding condition;

FIG. 4 is a diagram illustrating the conventional method of determining a welding condition;

FIG. 5 is a diagram illustrating the conventional method of determining a welding condition;

FIG. 6 is a diagram illustrating the conventional method of determining a welding condition;

FIG. 7 is a diagram showing an example of a hardware configuration of a controller according to an embodiment of the present invention;

FIG. 8 is a diagram showing an example of a functional configuration of a controller according to an embodiment of the present invention;

FIG. 9 is a diagram showing a behavior of a work state monitoring unit;

FIG. 10 is a diagram showing a behavior of the work state monitoring unit; and

FIG. 11 is a diagram showing a behavior of a welding condition controlling unit.

### DETAILED DESCRIPTION OF THE PREFERRED EMBODIMENTS

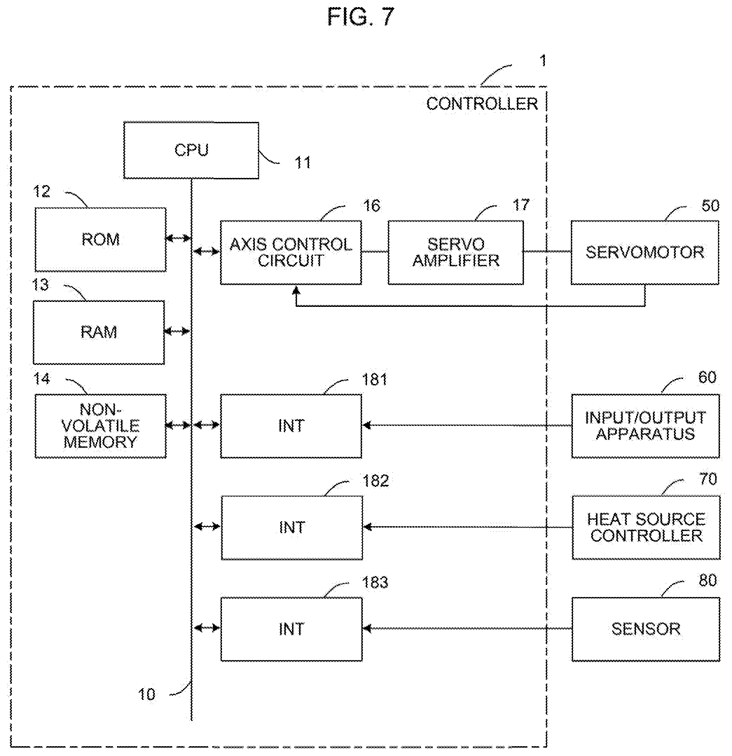

FIG. 7 is a schematic diagram of a hardware configuration showing a main part of a controller 1. The controller 1 is an apparatus that controls a welding machine including a laser welder 20 (see FIG. 9). The controller 1 has a CPU 11, a ROM 12, a RAM 13, a non-volatile memory 14, a bus 10, an axis control circuit 16, a servo amplifier 17, and interfaces 181, 182, and 183. The controller 1 connects with a servomotor 50, an input/output apparatus 60, a heat source controller 70, and a sensor 80.

The CPU 11 is a processor that takes overall control of the controller 1. The CPU 11 reads a system program stored in the ROM 12 via the bus 10 and controls the whole controller 1 according to the system program.

The ROM 12 stores system programs in advance for carrying out various kinds of control and the like of the welding machine.

The RAM 13 temporarily stores temporary calculation data, display data, data input by an operator via the input/output apparatus 60, programs, and the like.

The non-volatile memory 14, which is backed up with, for example, a battery not shown, retains a storing state even in the event of a power supply interruption to the controller 1. The non-volatile memory 14 stores data input from the input/output apparatus 60, programs, and the like. The program and data stored in the non-volatile memory 14 may be deployed to the RAM 13 during execution and use thereof.

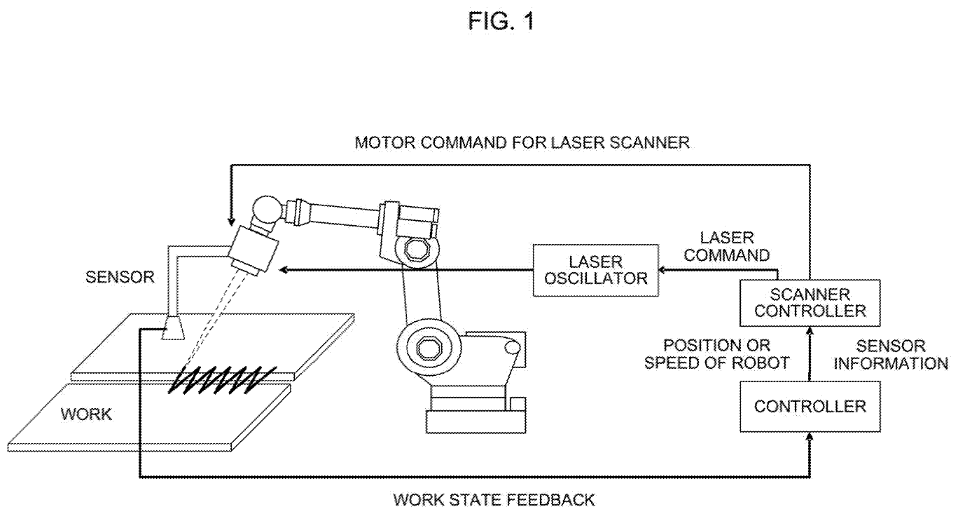

The axis control circuit 16 controls a motion axis of the welding machine. In the case of utilizing a robot as shown in FIG. 1, for example, the axis control circuit 16 receives a movement command quantity for the axis output by the CPU 11 to output a movement command for the robot's motion axis to the servo amplifier 17.

The servo amplifier 17 receives the movement command for the axis output by the axis control circuit 16 to activate the servomotor 50.

The activation by the servo amplifier 17 causes the servomotor 50 to move the motion axis of the welding machine. The servomotor 50 typically incorporates a position/speed detector. The position/speed detector outputs position/speed feedback signals, which are fed back to the axis control circuit 16, resulting in position/speed feedback control.

Note that FIG. 7 shows the axis control circuit 16, the servo amplifier 17, and the servomotor 50 only one by one, each of which is actually prepared as many as the number of axes included in the welding machine to be controlled.

The input/output apparatus 60, which is a data input/output apparatus equipped with a display, a hardware key, and the like, is typically a console panel. The input/output apparatus 60 displays information received from the CPU 11 via the interface 181 on the display. The input/output apparatus 60 passes commands, data, and the like input from the hardware key or the like to the CPU 11 via the interface 181.

The heat source controller 70 is an apparatus that controls a welding heat source. In the case of laser welding, for example, the heat source controller 70 is a scanner controller and outputs a laser command to a laser oscillator not shown to control the laser output. The heat source controller 70 also outputs a motor command to a laser scanner not shown to control the behavior of the laser scanner. The heat source controller 70 controls the heat source depending on information received from the CPU 11 via the interface 182.

The sensor 80, which is a sensor that detects a work state near a welding position, is typically an optical sensor. The sensor 80 is usually independent of the laser scanner but attached together with the laser scanner to the distal end of the robot's arm. The sensor 80 passes the detected work state to the CPU 11 via the interface 183.

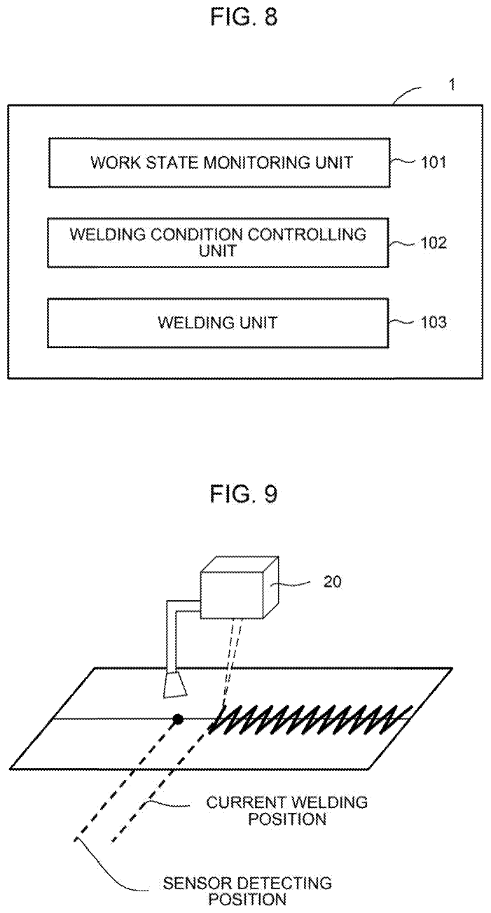

FIG. 8 is a block diagram schematically showing a functional configuration of the controller 1. The controller 1 has a work state monitoring unit 101, a welding condition controlling unit 102, and a welding unit 103.

As shown in FIG. 9, the work state monitoring unit 101 uses the sensor 80 to monitor a portion a little ahead of a current welding position, in other words, a welding position after predetermined time, i.e. a welding position for future, and to measure a work gap d. For example, the work state monitoring unit 101 takes an image of a portion a little ahead of a current welding position with an optical camera as the sensor 80 and obtains it per control cycle. The work state monitoring unit 101 can use the obtained image to specify a work gap d by a known image processing technique. The work state monitoring unit 101 accumulates the work gap d in a storage area not shown. This generates a time series data set of the work gap d.

The welding condition controlling unit 102 calculates a statistical value of the work gap d based on the time series data set of the work gap d generated by the work state monitoring unit 101. The statistical quantity, which can preferably eliminate fluctuation of the work gap d, is typically an average, a median, or the like of the work gap d obtained within a predetermined interval, that is a time width, inclusive of a current welding position. In other words, the statistical quantity is an average, a median, or the like of the work gap d collected and accumulated at welding positions for future and past and the like.

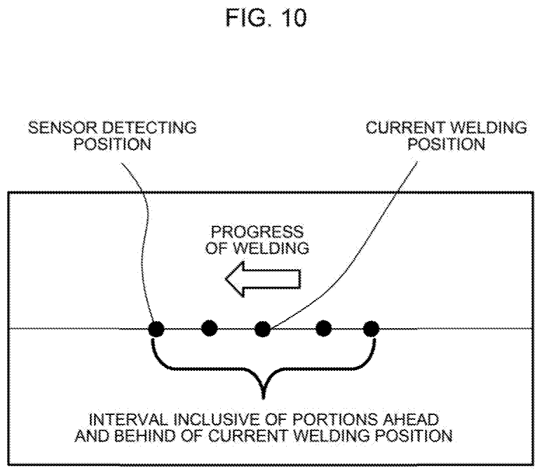

As shown in FIG. 10, when the welding machine is processing a current welding position, the work state monitoring unit 101 obtains the work gap d at a portion a little ahead of the current welding position, that is a welding position for future. Before that, the work state monitoring unit 101 has already obtained and accumulated the work gap d at the current welding position and at a welding position for further past. The welding condition controlling unit 102 can thus calculate a statistical value of the work gap d obtained within an interval inclusive of the portions ahead and behind of the current welding position.

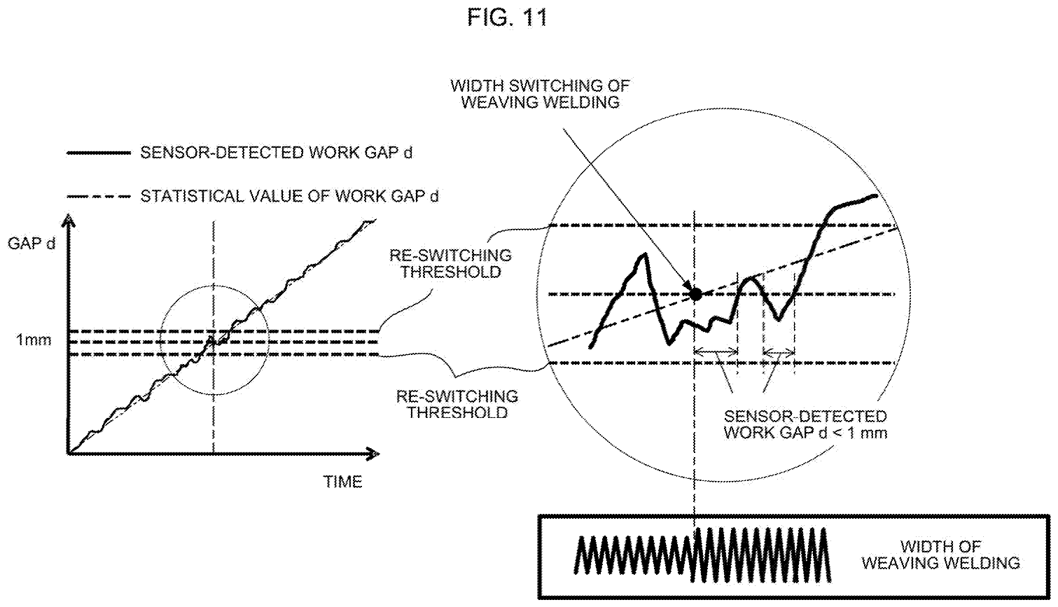

As shown in FIG. 11, once the welding condition controlling unit 102 switches a welding condition based on the statistical value of the work gap d, then it preferably keeps the welding condition un-switched until the statistical value of the work gap d varies beyond a predetermined width (hereinafter, referred to as a re-switching threshold). Note that, as shown in FIG. 11, a re-switching threshold is typically set to each of the upper and the lower of the statistical value of the work gap d at the time of switching a welding condition. However, a re-switching threshold may be set to only one of the upper and the lower of the statistical value of the work gap d at the time of switching a welding condition.

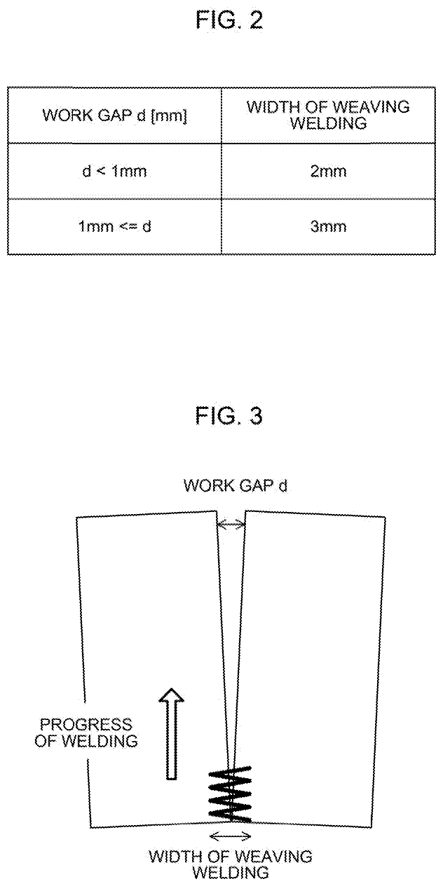

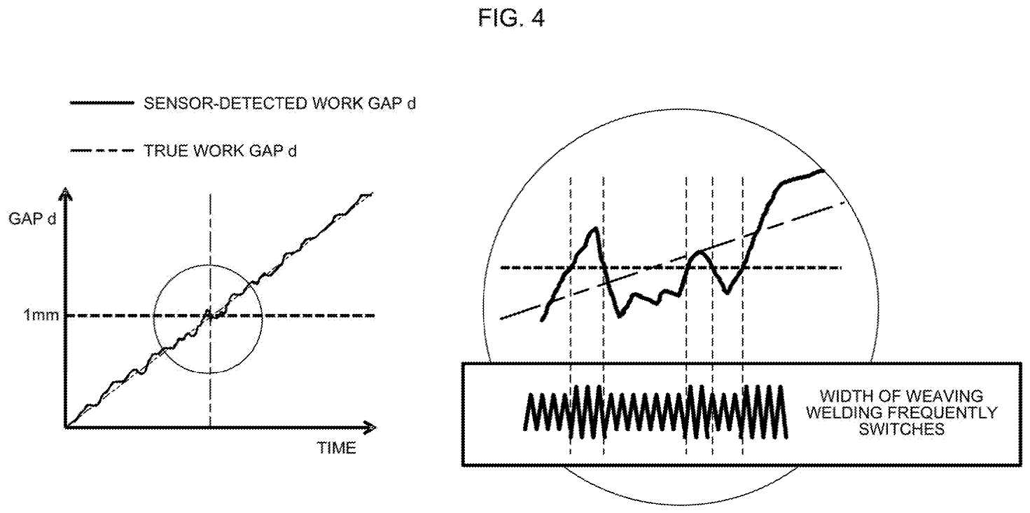

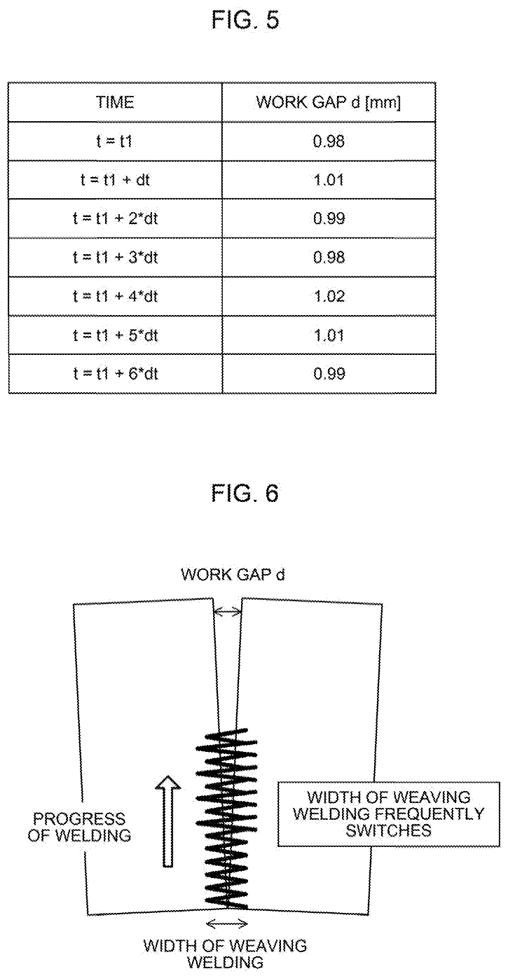

The chain double-dashed line in the graph of FIG. 11 shows a relationship between statistical values of the work gap d and the passage of processing time. The welding condition controlling unit 102 of this example switches the width of weaving welding from 2 mm to 3 mm according to the setting of FIG. 2 once an average of the work gap d is equal to or larger than 1 mm. After that, the work gap d detected by the sensor shows fluctuation as shown in the right diagram (enlarged diagram) of FIG. 11 and sometimes falls below 1 mm. The welding condition controlling unit 102 however keeps the welding condition un-switched after welding condition switching irrespective of a value of the work gap d detected by the sensor until an average of the work gap d exceeds the re-switching threshold. This can prevent frequent welding condition switching.

The welding unit 103 uses a welding condition determined by the welding condition controlling unit 102 to carry out welding processing.

The conventional controller would determine a welding condition depending on a work gap d at a current welding position as described above. Using raw data of the work gap d at a current welding position has sometimes resulted in frequent welding condition switching when the work gap d fluctuates. On the other hand, this embodiment uses a statistical value of the work gap d obtained within an interval inclusive of portions ahead and behind of the current welding position instead of the work gap d at the current welding position. This eliminates fluctuation of the work gap d in a way. This also prevents a welding condition from frequently switching.

According to this embodiment, the controller 1 uses a statistical value in a predetermined time width rather than raw information from the sensor to determine a welding condition. The controller 1 requests variation of the statistical value beyond a certain threshold for re-switching the welding condition. This can prevent frequent welding condition switching that would occur due to welding by taking the information from the sensor at face value.

The principal embodiments of the present invention have been described above, however, the present invention is not limited to the examples of the above embodiments and can be implemented in various modes by adding appropriate modifications. For example, the above embodiment has exemplified a laser as a welding heat source but the present invention is not limited to this and can utilize an arbitrary heat source. The above embodiment has also exemplified changing the width of weaving welding depending on a work gap d but the present invention is not limited to this and any welding condition that changes depending on the work state is applicable. The above embodiment has also exemplified an average of a work gap d as a statistical value but the present invention is not limited to this and may employ any statistical value that can eliminate small fluctuation of the work gap d.

The embodiments of the present invention have been described above, however, the present invention is not limited to the examples of the above embodiments and can be implemented in another mode by adding appropriate modifications.

1. A controller that determines a welding condition depending on a work state, the controller comprising:
a work state monitoring unit that monitors the work state at a welding position for future;
a welding condition controlling unit that calculates a statistical value based on the work state at the welding position for future and past and determines the welding condition depending on the statistical value; and
a welding unit that performs welding at a current welding position based on the welding condition.

2. The controller according to claim 1,
wherein the welding condition controlling unit keeps the welding condition unchanged until the statistical value varies beyond a predetermined threshold after determining the welding condition.

3. The controller according to claim 1,
wherein the work state is a width between a plurality of workpieces to be welded, and
the statistical value is an average of the width between the workpieces.
